(19) United States
(12) Patent Application Publication
(10) Pub. No.: US 2022/0222449 A1
(43) Pub. Date: Jul. 14, 2022

(54) PRESENTATION TRANSCRIPTS

(71) Applicant: Hewlett-Packard Development Company, L.P., Spring, TX (US)

(72) Inventors: Rafael Dal Zotto, Porto Alegre (BR); Gareth R. Westlake, Spring, TX (US)

(73) Assignee: Hewlett-Packard Development Company, L.P., Spring, TX (US)

(21) Appl. No.: 17/608,509

(22) PCT Filed: Sep. 13, 2019
(86) PCT No.: PCT/US2019/050951

§ 371 Date: Nov. 3, 2021

(51) Int. Cl. G06F 40/58; G10L 15/26; H04N 7/15

(52) U.S. Cl. CPC G06F 40/58; H04N 7/15; G10L 15/26

(57) ABSTRACT

An example system may include a processor and a non-transitory machine-readable storage medium storing instructions executable by the processer to generate a real-time transcript of a live delivery of a presentation; provide a unique identification to an attendee within a physical proximity to the live delivery of the presentation; and provide, responsive to receiving the unique identification from a device associated with the attendee, the real-time transcript to the device associated with the attendee for display.

### BACKGROUND

Presentations may be utilized to communicate data to a presentation attendee. A presentation attendee may possess an attribute that influences his ability to participate in the presentation. For example, an attendee may have a characteristic that influences his ability to receive and/or understand the content being communicated in the presentation.

### BRIEF DESCRIPTION OF THE DRAWINGS

FIG. 1 illustrates an example of a system for generating presentation transcripts consistent with the present disclosure.

FIG. 2 illustrates an example of a presentation manager device for generating presentation transcripts consistent with the present disclosure.

FIG. 3 illustrates an example of a non-transitory machine-readable memory and processor for generating presentation transcripts consistent with the present disclosure.

FIG. 4 illustrates an example of a method for generating presentation transcripts consistent with the present disclosure.

### DETAILED DESCRIPTION

A presentation audience may be made up of a variety of attendees. The attendees may possess a diverse array of attributes. For example, a particular attendee may possess an attribute such as a language proficiency, an ability, a disability, an impairment, a position, etc. that influences his/her ability to receive and/or understand the content being communicated in the presentation.

In order to communicate the content of a presentation to each member of the audience, regardless of their particular attributes, a presenter may modify or augment the content to accommodate for the attributes. For example, a presenter may utilize an interpreter. An interpreter may include a person to interpret a presentation to the audience in a manner that accommodates for particular attributes. In one example, a presenter may utilize a sign language interpreter to translate their presentation into sign language for hearing impaired attendees in the audience.

Providing accommodations, such as an interpreter, for particular attributes may impose a burden on the presenter. For example, a presenter may be burdened to organize the accommodation, to pay for the accommodation, to advertise that the accommodation is available, and/or to control the dissemination of content shared via the accommodation. In addition, often a single accommodation or type of accommodation may not address the diverse attributes of the audience. For example, among hearing impaired audience attendees some may be fluent in sign language, while others may not. As such, a wide range of accommodations may be involved in ordered to accommodate the attributes of everyone in an audience.

In some examples, rather than organizing and/or utilizing an army of interpreters at the presentation, audience attendees may be provided with a transcript of the presentation that is formatted in a manner that accommodates their attributes. For example, a transcript of the presentation formatted in a manner that is understandable by the attendee may be provided to a device utilized by an attendee. However, controlling content dissemination may be a concern of a presenter. As such, a presenter may provide secure devices to each attendee of a presentation. However, providing secure devices to each attendee of a presentation may be organizationally and financially prohibitive.

Alternatively, a transcript may be provided to be utilized on an attendee's personal device. However, given the ease with which digital information can be copied and/or transmitted, providing transcript access to potentially non-secure devices may introduce a security risk to the content of the presentation. Further, providing transcript access to devices which may or may not be actually present at the presentation may introduce a security risk to the content of the presentation.

In contrast, examples consistent with the present disclosure may provide an attendee of a live-delivery of a presentation with a real-time transcript of the presentation in a secure manner. For example, examples consistent with the present disclosure may generate a real-time transcript of a live-delivery of a presentation; provide a unique identification to an attendee within a physical proximity to the live-delivery of the presentation; and provide, responsive to receiving the unique identification from the device, the real-time transcript to a device associated with the attendee for display. Examples consistent with the present disclosure may allow an attendee of a presentation to understand and participate in a presentation in real-time while providing a presenter with control over access to the content of the presentation.

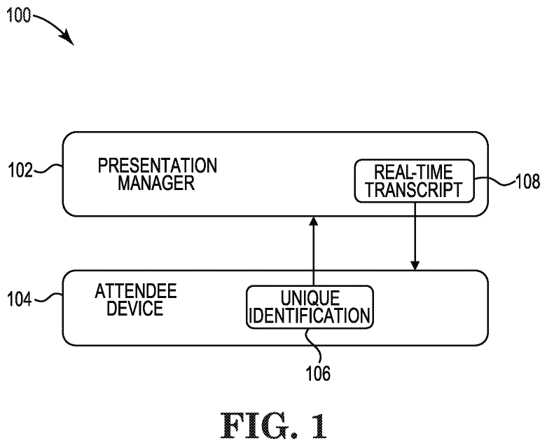

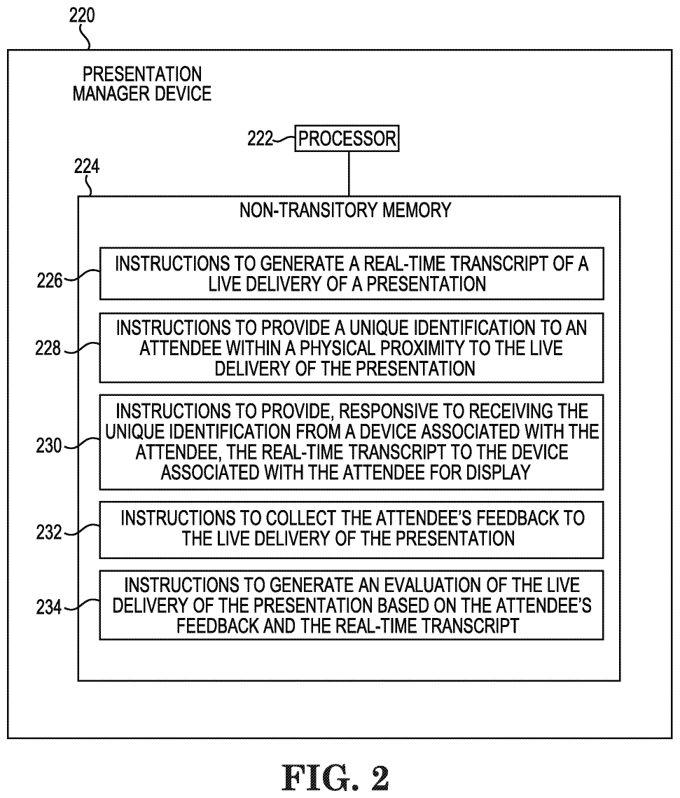

FIG. 1 illustrates an example of a system 100 for generating presentation transcripts consistent with the present disclosure. The described components and/or operations of the system 100 may include and/or be interchanged with the described components and/or operations described in relation to FIG. 2-FIG. 4

As used herein, a presentation may include the communication of information from a presenter to an audience of attendees. In some examples, the presentation may include the communication of information via a speech or talk performed by the presenter. For example, a person may deliver an oral presentation at a conference in order to communicate information to an audience of attendees.

In addition to the oral aspect, a presentation may include the communication of other types of content. For example, the presentation may include the communication of information via digital content. Digital content may include slides, videos, shared desktop views, displays, visual presentation aids, audio presentation aids, etc. That is, the digital content may include non-oral aspects of the presentation. In some examples, the oral and non-oral aspects may be delivered simultaneously during a presentation. For example, a presenter may display and/or reference displayed visual content while delivering the oral aspect of the presentation. For example, a presenter may describe and/or reference a presentation slide projected onto a screen in delivering his/her presentation.

In some examples, a presentation may include a live presentation. A live presentation may include a presentation that is performed live. That is, a live presentation may include a presentation that is not pre-recorded. A live presentation may include a presentation that is communicated to an audience contemporaneous with its performance or communication by the presenter.

The live presentation may be communicated to an audience of attendees by allowing the audience of attendees to observe the live presentation. For example, the audience of attendees may observe the live presentation via observation of the presenter in a same physical location as the audience and/or via observation of an electronic and/or digital representation of the presenter broadcasted to a broadcast location for the presentation. For example, the communication of the presentation may occur via observation of the live action presentation by the presenter by an audience of attendees located in a same conference room as the presenter. In another example, the communication of the presentation may occur via observation of a broadcast of the live action presentation by the presenter by an audience of attendees located in a same conference room designated as a broadcast location for the presentation (e.g., a conference room where a live webcast designated to be displayed for an audience of attendees).

A presentation may be utilized to communicate information and/or content to and/or receive feedback from an audience of presentation attendees. A presentation attendee may include a person that will physically attend the live-delivery of the presentation. The presentation attendee may attend the live-delivery of the presentation by being physically present in the same physical location (e.g., the same conference room) where the live-delivery of the presentation is delivered, displayed, and/or broadcasted.

A presentation attendee may have a variety of attributes. The attributes may include fluencies, impairments, abilities, disabilities, a particular location or vantage point within the physical location, etc. Such attributes may influence the presentation attendee's ability to receive and/or understand the information to be communicated via the presentation.

For example, an all-employee presentation event may occur in a physical location such as a company auditorium. The presentation event may be hosted by a presenter. The presenter may plan to deliver a presentation to the audience of employee attendees in the company auditorium. The presentation may include an oral component, such as the speech delivered by the presenter, and a non-oral component, such as a set of digital presentation slides that will be displayed and/or referenced during the presentation.

Some attendees in the employee audience may be hearing impaired. As such, these attendees may not be able to hear the audio portions of the presentation. Therefore, these hearing impaired attendees may not be able to receive and/or comprehend the information and/or content being communicated via the presentation. Alternatively, some attendees may not be fluent in the language that the presentation is being delivered in. As such, these non-fluent attendees may not be able to receive and/or comprehend the information and/or content being communicated via the presentation. In another example, the attendees may be located at a back of an auditorium where visibility and/or sound quality is degraded to an extent that these attendees may not be able to receive and/or comprehend the information and/or content being communicated via the presentation.

In a modern setting, an attendee may have an attendee device 104. An attendee device 104 may include a computing device associated with the attendee. For example, an attendee may be carrying an attendee device 104 such as a mobile computing device belonging to the attendee. For example, an attended device 104 may include a smartphone, a laptop computer, a tablet computer, a wearable computing device, an augmented reality computing device, a personal digital assistant, a digital media player, etc. that is associated with the attendee. In some examples, the attendee device 104 may be a personal computing device belonging to and/or owned by the attendee. In some examples, the attendee device 104 may be computing device provided to the attendee as part of their employment with an organization.

Examples consistent with the present disclosure may utilize the attendee device 104 to serve as a communication conduit between the presenter and the attendee. That is, the attendee 104 may be utilized to assist the attendee in scheduling, finding, attending, receiving, participating in, providing feedback on, and comprehending the presentation regardless of the particular attributes of the attendee that may influence their ability to do so. Further, examples consistent with the present disclosure may advertise, inform, and provide these features in an automated fashion that does not additionally burden the presenter or the attendee. Furthermore, examples consistent with the present disclosure may provide such features while maintaining controlled secure dissemination of the information and/or content shared in the live-delivery of the presentation.

The system 100 may include a presentation manager 102. A presentation manager 102 may include instructions executable by a processing resource to perform various functionalities described herein. The presentation manager 102 may reside in whole, or in part, at a computing device of the presenter (e.g., a computing device to be utilized by the presenter in the delivery of the presentation). The presentation manager 102 may reside in whole, or in part, at an attendee computing device 104. The presentation manager 102 may reside in whole, or in part, at a computing device in communication with the attendee computing device 104 and/or the computing device of the presenter (e.g., a server accessible to the attendee device 104 and/or the computing device of the presenter via a network connection). Although the presentation manager 102 is depicted as a single box 102 for simplicity of illustration, it is contemplated that portions of the presentation manager 102 and/or its functionality may be distributed across various devices, as described herein. In some examples, the presentation manager 102 may include a portion of an application that is installed at the computing device of the presenter and/or at the attendee device 104.

A presentation may be scheduled in advance of its occurrence. When scheduling a presentation, a presenter may utilize and/or interface with the presentation manager 102. For example, a presenter may create an event with the presentation manager 102. In some examples, creating an event may include specifying presentation details such as a name of the presentation, date of the presentation, time of the presentation, location of the presentation, description of the presentation, and or attendees to be invited to the presentation. Creating an event may be performed by entering the presentation details into the presentation manager 102 and/or may be performed by exporting the event details from a calendar or scheduling system to the presentation manager 102. For example, a presentation manager 102 may utilize a REST API service integrated into systems such as the Office365 system via customized plugins to automatically trigger a presentation event creation from a tool such as Outlook when the presentation event is added thereto.

A location of the presentation may include the physical location where the presentation will be delivered. That is, the location may include the physical location where the live-delivery of the presentation will be performed. The location may be specified to the presentation manager 102 by the presenter. The location may be specified as a geographic location, street address, building address, room address, room title, location title (e.g., Town Convention Center), GPS coordinates, etc. In some examples, the presentation manager 102 may utilize the specified location to identify, obtain, and/or understand the geolocation where the presentation may be held, which may be utilized in the manner described below. In some examples, the presentation manager 102 may utilize application programming interfaces (APIs) to obtain GPS coordinates for a presentation location and/or store the GPS coordinates and their association with a location in a cache. In this manner, the cache may be accessed to make future presentation event creation faster and more convenient the next time it occurs at the same location.

In addition, the presenter may specify to the presentation manager 102 a security level designation to be assigned to the presentation event. For example, the presenter may assign a public or private security level designation to the presentation event. A public security designation may be indicative of a presentation event that is accessible to anyone and/or includes no security restrictions. Alternatively, a private security designation may be indicative of a presentation event where the presentation manager 102 requests and/or validates a security detail (e.g., password, security credential, unique identification of the attendee, unique identification of the conference, biometric identifier of the attendee, etc.) from the attendee device 104. For example, before allowing an attendee to access features provided via the presentation manager 102 described in detail below (e.g., real-time transcripts 108, presentation content (oral and non-oral) sharing, feedback facilitation, etc.). The presenter may specify to the presentation manager 102 if and/or which security detail is to be utilized to authorize the attendee.

Conducting a presentation may include inviting attendees to view the presentation. A presenter may utilize and/or interface with the presentation manager 102 to prepare and/or send such invitations. The presentation manager 102 may manage the transmission of an invitation to an attendee. That is, the presentation manager 102 may send a digital invitation to an attendee device 104. A digital invitation may advertise a portion of the event details. For example, the invitation may advertise to an attendee the features that may be provided by the presentation manager 102 to the attendee device 104 during the live-delivery of the presentation. For example, the invitation may advertise to the attendee that a closed captioning, translation, presentation content streaming, and/or transcribing service may be made available to the attendee device 104 while attending the live-delivery of the presentation. For example, the invitation may advertise that the presentation manager 102 may provide a real-time transcript 108 and/or presentation content during the live-delivery of the presentation.

In some examples, the invitation may include a portion of a security mechanism to identify the attendee device 104 as being an authorized attendee device 104 to access or receive the features provided by the presentation manager 102 at the presentation. The security mechanism may include a token, a password, a key, or other mechanism to uniquely identify the attendee device 104 to the presentation manager 102 as being authorized to access or receive the features at the live-delivery of the presentation.

In some examples, the invitation and/or its acceptance by the attendee device 104 may operate to register and/or bind the attendee device 104 to the live-delivery of the presentation via the presentation manager 102. An attendee device 104 that is registered to and/or bound with the presentation may be utilized to access or receive the features provided by the presentation manager 102 during the live-delivery of the presentation. When an attendee accepts the invitation, he/she may specify an identity of an attendee device 104 that he/she wishes to utilize at the live-delivery of the presentation so that the specified attendee device 104 is registered to and/or bound with the presentation. Alternatively, the attendee device 104 at which the attendee receives the invitation and/or the attendee device 104 from which an invitation is accepted may be automatically registered to and/or bound with the presentation. As such, a mobile computing device other than an attendee device 104 that is registered to and/or bound with the presentation that attempts to access the features provided by the presentation manager 102 (perhaps even using, for example, a password associated with the invitation) will not be granted access as it is not the attendee device 104 that accepted the invitation and was registered to and/or bound with the presentation.

An additional component of conducting a presentation may include providing an attendee with instructions on how to travel to and/or arrive at the live-delivery of the presentation at a prescribed time. The presentation manager 102 may be utilized to manage and/or transmit such directions. For example, when an attendee accepts the invitation, the attendee 104 may be provided with instructions on how to get to the physical location of the live-delivery of the presentation. For example, the attendee device 104 may be provided with driving or walking directions to arrive at the physical location of the live-delivery of the presentation at its scheduled time. The directions may include and/or be based on the geolocation of the live-delivery of the which may be determined by the presentation manager 102 as described above.

The presentation manager 102 may also determine and/or track the physical location of the attendee. For example, an attendee device 104 may report its physical location to the presentation manager 102. Alternatively, a physical location of an attendee device 104 may be detected utilizing other computing devices and/or signal processing devices that may report the physical location of the attendee device 104 to the presentation manager 102. For example, the physical location of the attendee device 104 may be detected utilizing access points in and around the physical location of the live-delivery of the presentation.

The presentation manager 102 may utilize the physical location of the attendee device 104 to provide further event details to the attendee. For example, the presentation manager 102 may utilize the physical location of the attendee device 104 to provide the attendee device 104 with physical-proximity-to-the presentation-based event details and/or directions. For example, when the physical location of the attendee device 104 is detected within a few miles or blocks of the physical location of the live-delivery of the presentation, the presentation manager 102 may provide the attendee device 104 street-level driving and/or walking directions to the live-delivery of the presentation. Additionally, when the physical location of the attendee device 104 is detected within a few blocks of the physical location of the live-delivery of the presentation, the presentation manager 102 may provide the attendee device 104 with parking information.

When the physical location of the attended device 104 is detected within some number of feet of the physical location of the live-delivery of the presentation, the presentation manager 102 may provide the attendee device 104 with building-level/room-level walking directions to the presentation to the attendee's 104 device. For example, the presentation manager 102 may provide the attendee device 104 with directions to navigate within a building (e.g., parking structure, convention center, etc.) to the particular location (e.g., a conference room, etc.) within the building where the live-delivery of the presentation is to be held.

Alternatively, a presentation manager 102 may advertise a presentation in a more open and/or generic manner. For example, in presentation events designated as having a public security designation, the presentation manager 102 may push invitations, advertisements of the event details, and/or advertisements of the features to be provided by be presentation manager 102 at the event to all devices, or a subset of all devices, detected with a physical proximity to the live-delivery of the presentation around the time that the live-delivery of the presentation is scheduled.

The presentation manager 102 may provide various features to conference attendees. For example, a presentation manager 102 may provide a service that causes the content of the presentation to be delivered to the attendee device 104 in a format that is able ease the comprehension of the presentation by the attendee. For example, the presentation manager 102 may cause a real-time transcript 108 of the presentation to be generated. A real-time transcript 108 may include a text-based representation of what the presenter is saying in presenting the presentation. A real-time transcript 108 may include a transcript of the presentation audio that is generated substantially contemporaneously with the delivery of the audio (e.g., the speech) at the presentation. That is, the real-time transcript 108 may include a text script of the words spoken by the presenter, where the transcript is produced at the same time as or immediately following the presenter speaking the words.

For example, the voice of the presenter may be captured by a microphone present at the physical location of the live-delivery of the presentation. The voice may be digitally recorded and the recording may be processed and transcribed into a real-time transcript 108 of the presentation. Transcribing the voice into a real-time transcript 108 may include translating the voice to generate a real-time transcript 108 in a language other than the language that the presenter is speaking. In some examples, the presentation manager 102 may create the real-time transcript 108. In other examples, the presentation manager 102 may generate the real-time transcript 108 by forwarding the audio of the presentation captured from a microphone at a live-delivery of the presentation to a real-time transcribing service for immediate transcription and communication to attendee devices 104.

The presentation manager 102 may also collect and/or disseminate the content being displayed in the presentation. For example, the presentation manager 102 may collect and/or disseminate digital content such as slides, videos, shared desktop views, displays, visual presentation aids, audio presentation aids, etc. that are shared during the live-delivery of the presentation. The presentation manager 102 may, for example, provide a video of the presentation and/or a slide or slides being displayed and/or discussed in the live-deliver of the presentation. The presentation manager 102 may collect and/or disseminate the content via download, as an attachment, real-time streaming at the time and location of the live presentation, etc. For example, a presenter's computing device may be utilized to share or otherwise display the presentation content during the live-delivery of the presentation. The presenter's computing device that is sharing the presentation content may be utilized to perform a real-time streaming to a backend infrastructure. The presentation content may be flushed to an attendee device 104 from the presenter's computing device and/or from the backend infrastructure. For example, the presentation content may be flushed to an attendee device 104 when changes to the content occur (e.g., a slide being displayed is changed, something is drawn on a smart board display, an animation is triggered, switching between slides, etc.).

In some examples, a reactive connection between the presentation manager 102 and the attendee device 104 may be established. For example, when an attendee device 104 enters into a physical location of a live-delivery of the presentation, the presence of the attendee device 104 may be detected. For example, the attendee device 104 may have its GPS locating system activated. Once the attendee device 104 GPS locating system detects that it is located within a physical proximity to a location where the live-delivery of the presentation is scheduled, a notification may be pushed to the attendee device 104. The push notification may notify the attendee via the attendee device 104 that the real-time transcript 108 and/or the content being displayed in the presentation may be provided to the attendee device 104 from the presentation manager 102. In other examples, the attendee device 104 may be provided a notification via over-the-air advertisements. For example, proximity-limited over-the-air advertisements may be provided via Bluetooth, Radio, RFID, NFC, etc. communication technologies.

In some examples, a pro-active connection between the presentation manager 102 and the attendee device 104 may be established. For example, an attendee may utilize the attendee device 104 to search (e.g., utilizing an application) for nearby live-delivery presentation events. In such examples, the attendee device 104 may utilize its geolocation and/or the geolocation of its user, as determined utilizing a GPS locating system, to identify nearby live-delivery presentation events. For example, an attendee may search and/or have advertisements automatically pushed to their attendee device 104 for live-delivery presentation events occurring near them while they are standing in a convention center.

In some examples, a unique identification 106 may be provided to an attendee and/or an attendee device 104. The unique identification 106 may include a security mechanism that uniquely identifies the attendee, attendee device 104, and/or the presentation event that the attendee is attending. The unique identification 106 may be utilized as an access control mechanism to restrict access to the content of the presentation (e.g., real-time transcript 108 of the presentation, visual content of being presented in the presentation, etc.). For example, access to the content of the presentation may be limited to attendee devices 104 that provide the unique identification 106 corresponding to the live-delivery of the presentation to the presentation manager 102.

As described above, controlling the dissemination of digital information may be a concern of a presenter. As described herein, the system 100 may be utilized to disseminate the content of the presentation (e.g., real-time transcript 108 of the presentation, visual content of being presented in the presentation, etc.). The presenter may utilize system 100 to control the dissemination of the content of the presentation effectively limiting its dissemination to an audience within a physical proximity to the live-delivery of the presentation. By limiting the communication of the content to attendee devices 104 that are physically present at the live-delivery of the presentation, the control over the content may be supplemented by surveillance, physical access control, and/or other security measures that are implemented at the physical location where the live-delivery of the presentation is occurring.

For example, when a presentation event is designated as having a private security designation, a unique identification 106 may be utilized to restrict access to the content of the live-delivery of the presentation to authorized attendees. The unique identification 106 may be provided to an attendee in a proximity-limited manner. For example, the unique identification 106 may be provided to attendees and/or attendee devices 104 that are physically present within a physical proximity of the live-delivery of the presentation, but not to people or devices that are outside the physical proximity to the live-delivery of the presentation.

In some examples, the unique identification 106 may be provided attendee device 104 based on a determination of a geolocation of the attendee and/or the attendee device 104 relative to the location of the live-delivery of the presentation. For example, an attended device 104 may utilize its GPS locating system to determine its geolocation and/or whether it is within a physical proximity to the live-delivery of the presentation. The attendee device 104 may report its geolocation and/or whether it is within a physical proximity to the live-delivery of the presentation to the presentation manager 102 and/or a computing device communicably coupled to the presentation manager 102. Responsive to the GPS-based determination that the attendee device 104 is within a physical proximity (e.g., within a same room, within a predetermined distance from a presenter, within a predetermined distance from a presenter's device, within a predetermined distance to a presentation meeting room, within a predetermined distance to a presentation manager 102, etc.) to a live-delivery of the presentation, the unique identification 106 may be pushed to the attendee device 104. The unique identification 106 may be pushed to the attendee device 104 from a presentation manager 102, backend infrastructure, and/or some other computing device present in the physical environment of the live-delivery of the presentation.

In some examples, the unique identification 106 may be provided to an attendee through manual communication. For example, the unique identification may be provided to the attendee utilizing a non-automated transmission of the unique identification 106. For example, the unique identification 106 may be manually transmitted from a presenter, via announcement, to an attendee. For example, a presenter may recite and/or display a unique identification 106 at the live-delivery of the presentation. The attendee may manually input the announced unique identification 106 into their attendee device 104. The unique identification 106 may be communicated from the attendee device 104 to the presentation manager 102 and/or to another computing device present in the physical environment of the live-delivery of the presentation.

In another example, the unique identification 106 may be provided to the attendee device 104 utilizing an over-the-air broadcasting method. For example, a communication device utilizing electromagnetic fields and radio waves to track, identify, and/or communicate with another device may be positioned in the physical location of the live-delivery of the presentation. For example, a radio frequency identification (RFID) tag may be located at the physical location of the live-delivery of the presentation. The RFID tag may include an electronic communication device that may be activated, scanned, and/or have its signal detected via the attendee device 104. The RFID tag may transmit the unique identification 106 to the attendee device 104 via radio waves during the scanning. Due to the limited transmission range of RFID tags, the unique identification 106 communication may be limited to attendees in a physical proximity (e.g., the effective signal range of the RFID tag) to the live-delivery of the presentation.

In some examples, a communication device utilizing a set of communication protocols that may enable two electronic devices to establish contactless communication such as by utilizing electromagnets and/or loop antennas may be positioned in the physical location of the live-delivery of the presentation. For example, a near field communication (NFC) electronic communication device may be located at the physical location of the live-delivery of the presentation. The NFC device may communicate with and/or have its signal detected by the attendee device 104. The NFC device may transmit the unique identification 106 to the attendee device 104. Due to the limited transmission range of NFC device, the unique identification 106 communication may be limited to attendees in a physical proximity (e.g., the effective signal range of the NFC device) to the live-delivery of the presentation.

In some examples, a communication device utilizing a wireless technology standard for exchanging data between fixed and/or mobile devices over short distances utilizing short-wavelength UHF radio waves may be positioned in the physical location of the live-delivery of the presentation. For example, a Bluetooth electronic communication device may be located at the physical location of the live-delivery of the presentation. The Bluetooth device may communicate with and/or have its signal detected by the attendee device 104. The Bluetooth device may transmit the unique identification 106 to the attendee device. Due to the limited transmission range of Bluetooth device, the unique identification 106 communication may be limited to attendees in a physical proximity (e.g., the effective signal range of the Bluetooth device) to the live-delivery of the presentation.

In some examples, a communication device utilizing radio waves to provide wireless high-speed network connections to devices may be positioned in the physical location of the live-delivery of the presentation. For example, a Wi-Fi electronic communication device may be located at the physical location of the live-delivery of the presentation. The Wi-Fi device may communicate with and/or have its signal detected by the attendee device 104. The Wi-Fi device may transmit the unique identification 106 to the attendee device 104. Due to the limited transmission range of Wi-Fi device, the unique identification 106 communication may be limited to attendees in a physical proximity (e.g., the effective signal range of the Wi-Fi device) to the live-delivery of the presentation.

In some examples, the unique identification 106 may be provided to the attendee device 104 utilizing a machine-readable optical label. For example, a barcode such as a quick response (QR) code that may be located in the physical environment of the live-delivery of the presentation. The QR code may include data directly providing the unique identification 106 to the scanning device and/or may include data pointing to a website or application providing the unique identification 106 to the scanning device. For example, an attendee device 104 may scan the QR code and, in response, receive the unique identification 106. In order to scan the machine-readable optical label, the attendee device 104 may be in visual range of the machine-readable optical label. As such, the dissemination of the unique identification 106 may be limited to attendees in a physical proximity (e.g., the visual range of the machine-readable optical label) to the live-delivery of the presentation.

The attendee device 104 may provide the unique identification 106 to the presentation manager 102. For example, the attendee device 104 may submit the unique identification 106 to the presentation manager 102 in order to initiate a session with the presentation manager 102. Initiating a session with the presentation manager may include initiating access to the features and/or presentation content provided by the presentation manager 102.

In some examples, responsive to receiving the unique identification 106 from the attendee device 104, the presentation manager 102 may provide the attendee device 104 and/or another device associated with the attendee with the real-time transcript 108. That is, the presentation manager 102 may provide the attendee device 104 and/or another device associated with the attendee with the real-time transcript 108 of the live-delivery of the presentation as the live-delivery of the presentation is occurring. For example, the presentation manager 102 may provide the attendee device 104 and/or another device associated with the attendee with a real-time transcript 108 of what the presenter is saying substantially simultaneous to presenter actually saying it while the attendee is at the live-delivery of the presentation.

In some examples, the attendee device 104 may include a personal display viewable by the attendee during the presentation. For example, the attendee device 104 may include a smartphone that the attendee may view during the live-delivery of the presentation. However, an attendee may find it difficult, distracting, and/or disorienting to reference their personal screen to read the real-time transcript 108 while simultaneously trying to view presentation content being referenced by the presenter in, for example, the front of a meeting room. That is, the attendee may constantly be glancing back and forth between their phone screen and the presenter in front of the room and may experience discomfort or miss a portion of the real-time transcript 108 and/or the presentation content outside of the real-time transcript.

As such, responsive to receiving the unique identification 106 from the attendee device 104, the presentation manager 102 may additionally provide the attendee device 104 and/or another device associated with the attendee with other presentation content. For example, the presentation manager 102 may provide the attendee device 104 and/or another device associated with the attendee with digital content such as slides, videos, shared desktop views, displays, visual presentation aids, audio presentation aids, a video view of the presentation, etc. being presented in the live-delivery of the presentation. The presentation manager 102 may stream the additional digital content to the attendee device 104 in substantially real time. Alternatively, the presentation manager 102 may provide the additional content through an a priori download to be referenced and/or controlled by the attendee during the live-delivery of the presentation. As such, the attendee may experience a holistic live-delivery presentation experience on their device 104 that is tailored to their attributes. The presenter, on the other hand, may provide the attendees with access to the presentation content in a format tailored to the attributes of each individual attendee in the audience in a proximity-controlled manner to control dissemination of the data. Access to the presentation content including the real-time transcript 108 and other presentation content may be terminated to the attendee device 104 following the conclusion of the presentation.

Additional security measures may be implemented by the presentation manager 102 to limit access to the presentation content to authorized users. For example, access to the real-time transcript 108 and/or other presentation content may be password protected and/or protected by some other authentication mechanism. That is, an attendee may face an authentication challenge in order to gain access to the real-time transcript 108 and/or other presentation content. As described above, the additional security may include a confirmation that the attendee device 104 is the device that accepted an invitation to the presentation event and/or was specifically identified as an authorized device. In some examples, biometric authentication mechanisms may be utilized to restrict access to the real-time transcript 108 and/or other presentation content. For example, access to the real-time transcript 108 and/or other presentation content might be made conditional upon a viewing face being recognized as someone that was authorized to join (regardless of having the passcode to join the meeting). Other examples might use the finger reader to occasionally check the attendee's identity (for example, using random intervals of time an attendee may be instructed to identify himself/herself using biometric factors, etc.).

Part of attending a live-delivery of a presentation may include participating in the presentation. However, for some attendees their attributes may frustrate their participation in the presentation. Therefore, the presentation manager 102 may not only provide the real-time transcript 108 and/or other presentation content of the live-delivery of the presentation to the attendee device 104, but may also transform the attendee device 104 into a communication conduit for the attendee to participate in the live-delivery of the presentation. For example, the attendee may provide feedback to a presenter through the attendee device 104. As used herein, feedback may include a critique of the presentation, a question for the presenter, a concern, a correction, a citation, an opinion related to the presentation, or any other presentation related communication to be considered by the presenter.

The presentation manager 102 may collect and/or receive the feedback. The presentation manager 102 may translate the feedback from a first format into a format understandable by the presenter. The presentation manager 102 may present the feedback to the presenter. In some examples, the presentation manager 102 may provide the feedback to the presenter in real-time and/or collate the feedback to be presented at a later time. Based on this configuration, a question raised by an attendee may be shown to a presenter and may be addressed when appropriate. In some examples, the feedback may be associated with the identity of the attendee and in others the feedback may be kept anonymous.

The presentation manager 102 may compile the real-time transcript 108, other presentation content, and/or feedback from the attendee device 104. The presentation manager 102 may generate an evaluation of the presentation from the real-time transcript 108, other presentation content, and/or feedback from the attendee device 104. The evaluation may include a comprehensive timeline for the presentation event compiled from the real-time transcript 108, other presentation content, and/or feedback from the attendee device 104. For example, the presentation manager 102 may generate a timeline that is an integration and/or description of the real-time transcript 108, other presentation content, and/or feedback from the attendee device 104. The comprehensive timeline may be analyzed to determine the transcript of the audio of a portion of the presentation, the feedback provided during that portion of the presentation, the presentation content being shared during that portion of the presentation, etc. For example, analysis of the comprehensive timeline may be utilized to determine for any given moment in a presentation what was presented orally at that moment, what was presented visually at the moment, what feedback was received at that moment, what question was asked at that moment, and/or what answer or response a presenter provided in that moment.

The comprehensive timeline may be analyzed to extract statistical content from it. The statistical content may identify areas of the presentation where more questions were posed which may allow a presenter to understand and better organize the presentation event and the presentation content. The evaluation provided by the presentation manager 102 may include and/or be based on the statistical analysis. In some examples, a presenter may utilize the statistical content to identify the areas of interest based on an amount of feedback.

In some examples, the compiled the real-time transcript 108, other presentation content, and/or feedback from the attendee device 104 may be submitted to a third-party service. For examples, a third-party data analysis service may execute key phrase extraction, sentiment analysis, entity recognition and topic modeling of the presentation content from the real-time transcript 108, other presentation content, and/or feedback from the attendee device 104. For example, a third-party service may utilize machine learning models and/or algorithms to process a set of textual data and generate useful insights that may be analyzed to better understand the presentation event as described above. As such, the evaluation provided by the presentation manager 102 may include these results.

The above described evaluations, including the analysis and/or statistical content from the compiled the real-time transcript 108, other presentation content, and/or feedback from the attendee device 104, may be processed to make informed decisions regarding organizing and/or modifying the presentation. In some examples, the entirety of the live-delivery of the presentation may, as whole, be processed in determining such modifications. That is, all interactions made between the attendees and the presenter may be considered in identifying modifications. In some examples, a portion of the presentation event may be processed. In some examples, the presenter posture and behavior may be the focus of the analysis and/or statistical content. In some examples, the audience may be the focus of the analysis and/or statistical content.

FIG. 2 illustrates an example of a presentation manager device 220 for generating presentation transcripts consistent with the present disclosure. The described components and/or operations described with respect to the presentation manager device 220 may include and/or be interchanged with the described components and/or operations described in relation to FIG. 1 and FIG. 3-FIG. 4.

The presentation manager device 220 may include a computing device. For example, the presentation manager device 220 may include a processor 222 and/or a non-transitory memory 224. The non-transitory memory 224 may include instructions (e.g., 226, 228, 230, 232, 234, etc.) that, when executed by the processor 222, cause the presentation manager device 220 to perform various operations described herein. While the presentation manager device 220 is illustrated as a single component, it is contemplated that the presentation manager device 220 may be distributed among and/or inclusive of a plurality of such components.

The presentation manager device 220 may include a server. For example, the presentation manager device 220 may include a backend computing infrastructure. The backend computing infrastructure may be in communication with applications executing on a presenter device and/or an attendee's device.

The presentation manager device 220 may execute instructions 226 to generate real-time transcript of a live-delivery of a presentation. For example, the real-time transcript may include a text script of what was said by the presenter during the presentation. In addition, a presenter may present visual content that additionally include audio. For example, a presenter may present a video that includes an audio component. In such examples, the real-time transcript may include a text script of the audio component of the video as well.

In some examples, the real-time transcript of the audio includes a translation of audio of the live-delivery of the presentation from a first language to a second language. In some examples, the first language (used by the presenter) and/or the second language (used by the attendee) may be automatically detected and/or adjusted based on the abilities/disabilities of the attendee.

The presentation manager device 220 may execute instructions 228 to provide a unique identification to an attendee within a physical proximity to the live-delivery of the presentation. The physical proximity of the attendee to the live-delivery of the presentation may be determined based on a geolocation of the device associated with the attendee device associated with the attendee relative to the location of the live-delivery of the presentation. In some examples, the unique identification may be provided by an RFID tag located at the live-delivery of the presentation. In some examples, the unique identification may be provided to the device associated with the attendee via an over the air local advertisement originating from the live-delivery of the presentation. In some examples, the unique identification may be provided to the device associated with the attendee via a scan of a QR code present at the live-delivery of the presentation. In some examples, the unique identification may be provided to the device associated with the attendee via an NFC signal originating from a device located at the live-delivery of the presentation. In some examples, the unique identification may be a code announced to the audience by a presenter at a live-delivery of the presentation and manually entered into an attendee device by the attendee.

The presentation manager device 220 may execute instructions 230 to provide, responsive to receiving the unique identification from the device associated with the attendee, the real-time transcript to the device associated with the attendee. The real-time transcript may be provided to the device to be displayed thereupon to the attendee during the live-delivery of the presentation. In some examples, the presentation manager device 220 may provide visual content being presented in the live-delivery of the presentation to the device associated with the attendee. The visual content may be provided to the device to be displayed on the device simultaneously with the real-time transcript. In some examples, the visual content may be broadcasted or streamed to the device associated with the attendee during the live-delivery of the presentation. In some examples, the visual content may be provided to the attendee device as an a priori download to be viewed during the live-delivery of the presentation.

The presentation manager device 220 may execute instructions 232 to collect the attendee's feedback to the live-delivery of the presentation. The presentation manager device 220 may collect a critique of the presentation, a question for the presenter, a concern, a correction, a citation, an opinion related to the presentation, or other presentation related communication to be considered by the presenter from attendees in the audience. The feedback may be submitted to the presentation manager device 220 via the device associated with the attendee during the live-delivery of the presentation.

The presentation manager device 220 may execute instructions 234 to generate an evaluation of the live-delivery of the presentation. For example, based on the attendee's feedback and the real-time transcript, the presentation manager device 220 may generate an evaluation of the live-delivery of the presentation. The evaluation may identify portions of the presentation that may be modified, emphasized, clarified, etc. based on the flow of the presentation and feedback.

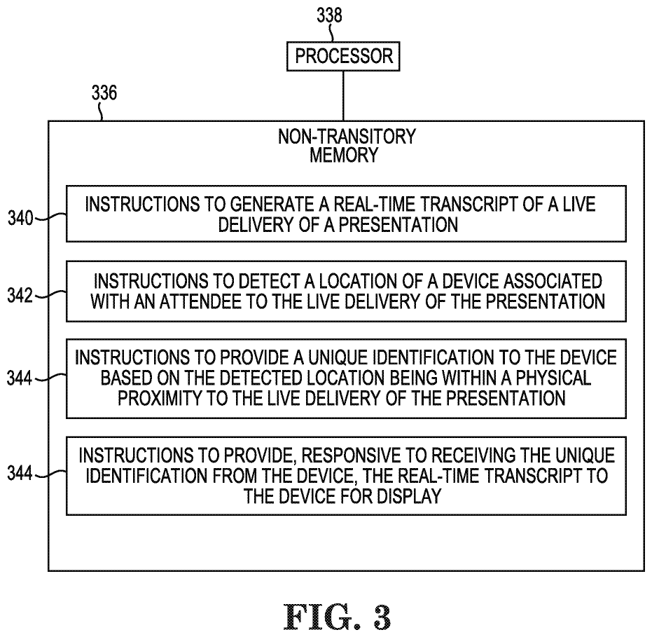

FIG. 3 illustrates an example of a non-transitory machine-readable memory 336 and processor for generating presentation transcripts consistent with the present disclosure. A memory resource, such as the non-transitory machine-readable memory 336, may be utilized to store instructions (e.g., 340, 342, 344, 348 etc.). The instructions may be executed by the processor 338 to perform the operations as described herein. The operations are not limited to a particular example described herein and may include and/or be interchanged with the described components and/or operations described in relation to FIG. 1-FIG. 2 and FIG. 4.

The non-transitory memory 336 may store instructions 340 executable by the processor 338 to generate a real-time transcript of a live-delivery of a presentation. The real-time transcript may be generated by processing audio captured at the live-delivery of the presentation and processing the audio in real time. The real-time transcript may include a readable text transcript of the audio spoken and/or otherwise presented in the presentation. The real-time transcript may be generated while the presentation is being delivered.

The non-transitory memory 336 may store instructions 342 executable by the processor 338 to detect a location of a device associated with an attendee to the live-delivery of the presentation. The location of the device associated with the attendee may be determined based on a GPS location reported by the device. The location of the device may be determined based on the device being within range of a radio signal transceiver. For example, the location of the device may be determined based on the device being within range of a Wi-Fi access point, a Bluetooth transceiver, and NFC device, an RFID tag, etc.

The physical location of the device associated with the attendee may be determined relative to the physical location of the live-delivery of the presentation. The location of the live-delivery of the presentation may be determined by a designated location for the presentation and/or the location of the presenter, the location of devices associated with the presenter, and/or the location of radio signal transceivers.

In some examples, the physical location of the device associated with the attendee relative to the physical location of the live-delivery of the presentation may be utilized to trigger notification to the device associated with the attendee. For example, a notification may be pushed to the device associated with the attendee based on the device being detected within a physical proximity to a location of the live-delivery of the presentation. The notification pushed to the device may include a notification regarding availability of the real-time transcript to attendees. For example, the notification may include an advertisement informing an attendee of details of a presentation and/or that a real-time transcript, visual content, and/or feedback delivery system is available to be provided at the attendee's device. Further, the notification may include detailed directions to reach the physical location of the live-delivery of the presentation from the physical location of the device associated with the attendee.

The non-transitory memory 336 may store instructions 344 executable to provide a unique identification to the device associated with the attendee. The unique identification may be provided based on the detected location of the device being within a physical proximity to the live-delivery of the presentation. That is, receiving the unique identification may be contingent upon being present within a physical proximity to the lie delivery of the presentation.

As described above, the physical location of the device associated with the attendee may be determined relative to the physical location of the live-delivery of the presentation. As such, once the device is detected within a physical proximity to the live-delivery of the presentation, a unique identification may be provided to the device. The device may then provide the unique identification as a means for authorization to receive the real-time transcript of the live-delivery of the presentation. The device may communicate the unique identification to a presentation manager over a network connection.

The non-transitory memory 336 may store instructions 344 executable to provide the real-time transcript to the device associated with the attendee. The real-time transcript may be provided to the device responsive to receiving the unique identification from the device. In some examples, real time visual content of the presentation may be provided to the device responsive to receiving the unique identification from the device.

Additionally, an attendee may enter their presentation related feedback on their associated devices. For example, an attendee may enter a critique of the presentation, a question for the presenter, a concern, a correction, a citation, an opinion related to the presentation, or any other presentation related communication to be considered by the presenter into their device during their attendance at the live-delivery of the presentation. As such, the attendee's feedback to the presentation may be collected from the device associated with the attendee. The feedback may be delivered to a device associated with a presenter conducting the live-delivery of the presentation. The feedback may be delivered to a presenter device in real time while the presenter is delivering the presentation to the audience.

An evaluation of the live-delivery of the presentation may be generated. For example, an analysis of the attendee's feedback, the real-time transcript, and/or other presented content may be performed to generate an evaluation of aspects of the presentation. For example, the evaluation may include event notes for the presentation. The evaluation may include a timeline of the real-time transcript, presentation content, and feedback for the presentation. The evaluation may include content summarization, sentiment analysis, key phrase identification, and/or topic modeling for the presentation. The evaluation may be delivered to the device associated with the presenter.

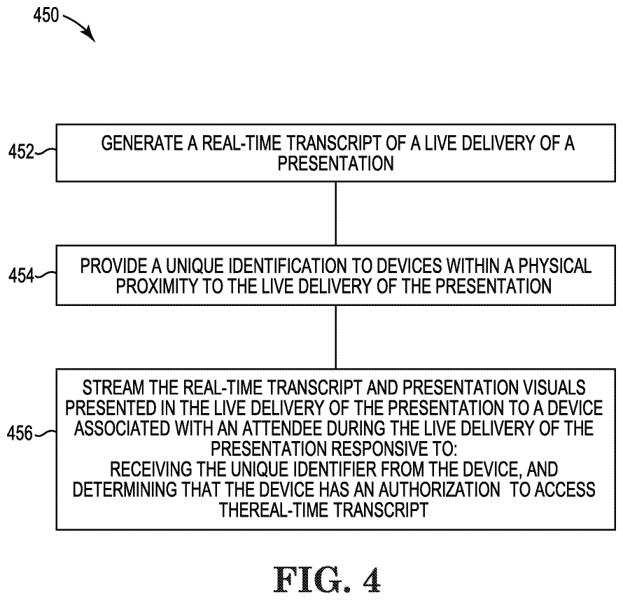

FIG. 4 illustrates an example of a method for generating presentation transcripts consistent with the present disclosure. The described components and/or operations of method 450 may include and/or be interchanged with the described components and/or operations described in relation to FIG. 1-FIG. 3.

At 452, the method 450 may include generating a real-time transcript of a live-delivery of a presentation. As described above, the real-time transcript may be a transcription and/or translation of audio from the live-delivery of the presentation that is prepared and/or communicated to recipients in real-time during the live-delivery of the presentation. The transcript may be prepared from an audio detected and/or recorded at the live-delivery of the presentation.

At 454, the method 450 may include streaming the real-time transcript and presentation visuals presented in the live-delivery of the presentation. The transcripts and visuals may be streamed in real-time immediately after they are detected and/or prepared. The transcripts and visuals may be streamed to the device associated with an attendee during the live-delivery of the presentation. In some examples, streaming the real-time transcript to the device may be performed by sending an updated presentation visual responsive to a determination that a presentation visual being presented at the live-delivery has been changed at the live-delivery. That is, to conserve computer and network resources, the streamed visuals may limit updates to the visuals to instances where the visual is changed from a previously displayed version of a visual. Alternatively, the transcripts and/or the visuals may be provided as an a priori download to the attendee's device prior to the delivery of the presentation.

The real-time transcript and presentation visuals may be provided to the attendee's device responsive to receiving the unique identification from the device associated with the attendee. Additionally, the real-time transcript and presentation visuals may be provided to the attendee's device responsive to determining that the device has an authorization to access the real-time transcript.

For example, the determining that the device has an authorization to access the real-time transcript may include determining that the device is registered as an authorized device for the presentation. For example, when an attendee accepts an invitation to attend a live-delivery of the presentation, his/her device may be registered as an authorized device for the live-delivery of the presentation. For example, determining that the device has an authorization to access the real-time transcript may include determining that the device is a device that was registered during an acceptance of such an invitation. In some examples, determining that the device has an authorization to access the real-time transcript may include determining that the device is the same device that accepted an invitation to attend the live-delivery of the presentation. That is, determining that the device has an authorization to access the real-time transcript may include determining that the device of the attendee is one that has a reserved “seat” to access the real-time transcript and visuals. In other examples, determining that the device has an authorization to access the real-time transcript may be based on authentication measures such as password challenged, security credential challenges, unique identification challenges, biometric identifier challenges, etc.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor, and
a non-transitory machine-readable storage medium to store instructions executable by the processor to:
generate a real-time transcript of a live-delivery of a presentation;
provide a unique identification to an attendee within a physical proximity to the live-delivery of the presentation; and
provide, responsive to receiving the unique identification from a device associated with the attendee, the real-time transcript to the device associated with the attendee for display.

2. The system of claim 1, wherein the physical proximity of the attendee to the live-delivery of the presentation is determined based on a geolocation of the device associated with the attended relative to the location of the live-delivery of the presentation.

3. The system of claim 1, wherein the real-time transcript of the audio includes a translation of audio of the live-delivery of the presentation from a first language to a second language.

4. The system of claim 1, including instructions executable by the processor to provide visual content being presented in the live-delivery of the presentation to the device associated with the attendee to be displayed on the device simultaneously with the real-time transcript.

5. The system of claim 1, wherein the unique identification is provided by a radio-frequency identification (RFID) tag located at the live-delivery of the presentation.

6. The system of claim 1, wherein the unique identification is provided to the device associated with the attendee via an over-the-air local advertisement originating from the live-delivery of the presentation.

7. The system of claim 1, wherein the unique identification is provided to the device associated with the attendee via a scan of a QR code present at the live-delivery of the presentation.

8. The system of claim 1, wherein the unique identification is provided to the device associated with the attendee via a near field communication (NFC) device present at the live-delivery of the presentation.

9. A non-transitory machine-readable storage medium comprising instructions executable by a processor to:
generate a real-time transcript of a live-delivery of a presentation;
detect a location of a device associated with an attendee relative to the live-delivery of the presentation;
provide a unique identification to the device based on the detected location being within a physical proximity to the live-delivery of the presentation; and
provide, responsive to receiving the unique identification from the device, the real-time transcript to the device for display.

10. The non-transitory machine-readable storage medium of claim 9, including instructions executable by the processor to deliver, based on the detected location of the device relative to a location of the live-delivery of the presentation, a notification to the device regarding availability of the real-time transcript to attendees.

11. The non-transitory machine-readable storage medium of claim 9, including instructions executable by the processor to:
collect the attendee's feedback to the presentation from the device associated with the attendee; and
deliver the feedback to a device associated with a presenter conducting the live-delivery of the presentation.

12. The non-transitory machine-readable storage medium of claim 11, including instructions executable by the processor to:
generate an evaluation of the live-delivery of the presentation based on the attendee's feedback and the real-time transcript; and
deliver the evaluation to the device associated with the presenter.

13. A method, comprising:
generating a real-time transcript of a live-delivery of a presentation;
providing a unique identification to devices within a physical proximity to the live-delivery of the presentation; and
streaming the real-time transcript and presentation visuals presented in the live-delivery of the presentation to a device associated with an attendee during the live-delivery of the presentation responsive to:
receiving the unique identification from the device, and
determining that the device has an authorization to access the real-time transcript.

14. The method of claim 13, including determining that the device has the authorization based on the device being a same device that was registered as an authorized device as part of accepting an invitation to attend the live-delivery of the presentation.

15. The method of claim 13, providing, responsive to detecting that the device associated with the attendee is within a threshold distance from the live-delivery of the presentation, building-level walking directions for reaching the physical proximity to the live-delivery of the presentation to the device associated with the attendee.
